(19) United States
(12) Patent Application Publication
(10) Pub. No.: US 2023/0419321 A1
(43) Pub. Date: Dec. 28, 2023

(54) USER REGULATION OF ACCOUNT CONTROL

(71) Applicant: Truist Bank, Charlotte, NC (US)

(72) Inventors: Yadhira Haydee Arroyo, Chicago, IL (US); Stephen Gary Hess, Palm Springs, CA (US); Nancy Wells, Kenosha, WI (US); LaTonja Barlow, Lenexa, KS (US); Sarah Katherine Nash, Raleigh, NC (US); Alex Heath Misiaszek, Cornelius, NC (US)

(73) Assignee: Truist Bank, Charlotte, NC (US)

(21) Appl. No.: 17/847,996

(22) Filed: Jun. 23, 2022

(51) Int. Cl. G06Q 20/40; G06Q 20/34; G06Q 20/38

(52) U.S. Cl. CPC G06Q 20/401; G06Q 20/382; G06Q 20/34

(57) ABSTRACT

A computer-implemented method includes receiving a request to initiate a modified security profile for a payment card. Additionally, the method may involve initiating the modified security profile for the payment card. The method may further involve receiving a request from a point of sale device to authorize a transaction by the payment card with the modified security profile. Moreover, the method may involve determining the transaction is not authorized by the modified security profile. Further, the method may involve transmitting a notification to the point of sales device to reject the transaction.

### TECHNICAL FIELD

The present disclosure relates generally to account control and, more particularly (although not necessarily exclusively), to restrictions implemented on user accounts.

### BACKGROUND

Payment cards, such as credit cards and debit cards, enable users to efficiently transfer funds. A payment card may be electronically linked to an account or accounts belonging to the user. These accounts may be deposit accounts or loan or credit accounts, and the card may be a means of authenticating the user. Users may have limited control over the operation of the payment cards during transactions.

### SUMMARY

In one-example, a non-transitory computer-readable medium may contain instructions that are executable by a processing device that may cause the processing device to perform operations. The operations include receiving a request to initiate a modified security profile for a payment card. The operations also include initiating the modified security profile for the payment card. Additionally, the operations include receiving a request from a point of sale device to authorize a transaction by the payment card with the modified profile. Further, the operations include determining that the transaction by the payment card is not authorized by the modified security profile. Furthermore, the operations include transmitting a notification to the point of sale device rejecting the transaction.

In an additional example, a system may include a processing device and a non-transitory computer-readable medium that may contain instructions for causing the processing device to perform operations. The operations also include initiating a modified security profile for the payment card. Additionally, the operations include receiving a request from a point of sale device to authorize a transaction by the payment card with the modified profile. Further, the operations include determining that the transaction by the payment card is not authorized by the modified security profile. Furthermore, the operations include transmitting a notification to the point of sale device rejecting the transaction.

In an additional example, a computer-implemented method may include receiving a request to initiate a modified security profile for a payment card. Additionally, the method may involve initiating the modified security profile for the payment card. The method may further involve receiving a request from a point of sale device to authorize a transaction by the payment card with the modified security profile. Moreover, the method may involve determining the transaction is not authorized by the modified security profile. Further, the method may involve transmitting a notification to the point of sales device to reject the transaction.

### BRIEF DESCRIPTION OF THE DRAWINGS

FIG. 1 is an example illustrative of a user initiating a modified security profile for a payment card, according to one example of the present disclosure.

FIG. 2 is a block diagram of an example computing device according to one example of the present disclosure.

FIG. 3 is a flow chart of an example of a process for implementing some aspects of the present disclosure.

### DETAILED DESCRIPTION

Certain aspects and examples of the present disclosure relate to modifying a security profile for a payment card. A payment card may be a physical card or card number issued by a financial institution, such as a bank, credit union, or a credit card company. Modifying the security profile for the payment card may entail altering restrictions on transactions that may be made with the payment card, a card number associated with the payment card, or an account associated with the payment card.

Transactions made with payment cards may be more ubiquitous than transactions made with physical cash. Payment cards may offer convenience but may also be vulnerable to misuse, either by fraudulent behavior or in some examples by a user's own behavior. Being able to control a payment card with respect to time, location, and merchants may offer a user control over both potential sources of fraud and the spending behaviors of the user or of other approved users.

For example, a user may recognize their own tendency to leave their payment card behind when opening a tab at a bar. In the present example, the bar may have a policy of physically keeping payment cards while patron's tabs are open. In such an example, the user may activate a modified security profile for their payment card. The modified security profile may block transactions made with the payment card for a time interval defined by the user, such as the time between 2 a.m. and 12 p.m. The modified security profile may place a spending limit on the payment card. The modified security profile may implement a multitude of restrictions on the payment card, such as implementing a spending limit for a certain period of time, blocking transactions for a different, second period of time, and requiring dual-factor authentication for a different, third period of time.

The user may modify the security profile for their payment card through a variety of processes. Example processes of modifying the security profile for the payment card may include interacting with a virtual assistant of a bank or credit card company, using a dedicated application on a smartphone, accessing a banking website, text messaging a service, emailing a service, or issuing commands at an automated teller machine (ATM). The user may activate and deactivate the security profile through the aforementioned examples or through other means. In examples where the security profile requires dual-factor authentication, the user may satisfy the dual-factor authentication through the aforementioned examples or through other means.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

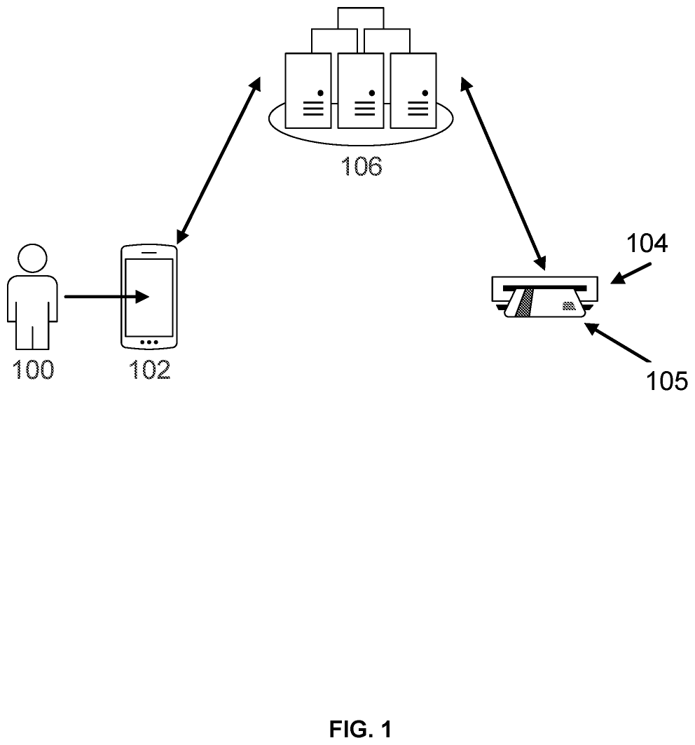

FIG. 1 is an example illustrative of a user 100 initiating a modified security profile for a payment card, according to one example of the present disclosure. The user 100 initiates the modified security profile by interacting with a smartphone 102. The smartphone 102 transmits the modifications to a data center 106 of a financial institution. A card reader 104, reading the payment card 105 of the user 100, references the data center 106 of the financial institution.

The data center 106 may be any suitable system used by a financial institution for managing payment cards and accounts related to payment cards. In some examples the user 100 may initiate the modified security profile by interacting with a banking website, a virtual assistant provided by the financial institution, an automated teller machine (ATM), an automated attendant over a phone call, text message, or an authorized employee of the financial institution. Other example means of initiating the modified security profile are also possible. The user 100 may alter the parameters of the modified security profile by the aforementioned examples as well as any other possible means. The user 100 may terminate the modified security profile by the aforementioned examples as well as any other possible means. In some examples, the modified security profile may require dual-factor authentication for transactions made with the payment card. In some such examples, dual-factor authentication may be satisfied by the aforementioned examples as well as any other possible processes.

The user 100 may use any combination of processes to control the aforementioned functionality related to the modified security profile. For example, the user 100 may alter the parameters of the modified security profile through a banking website, initiate the modified security profile with a virtual assistant of the financial institution, satisfy dual-factor authentication through text-message, and terminate the modified security profile via an automated attendant over a phone call.

In some examples, the card reader 104 may read a magnetic strip of the payment card 105. In some examples, the card reader 104 may read an integrated card circuit embedded within the payment card 105. In some examples, the card reader 104 may communicate with a radio-frequency identification chip embedded within the payment card 105. In some examples, the card reader 104 may receive a hand-typed entry of a card number associated with the payment card 105.

The data center 106 of the financial institution may store the modified security profile of the user 100. The data center 106 may allow, block, or place an authorization hold on a transaction requested by the card reader 104 in response to the parameters of the modified security profile and in response to whether the modified security profile is active.

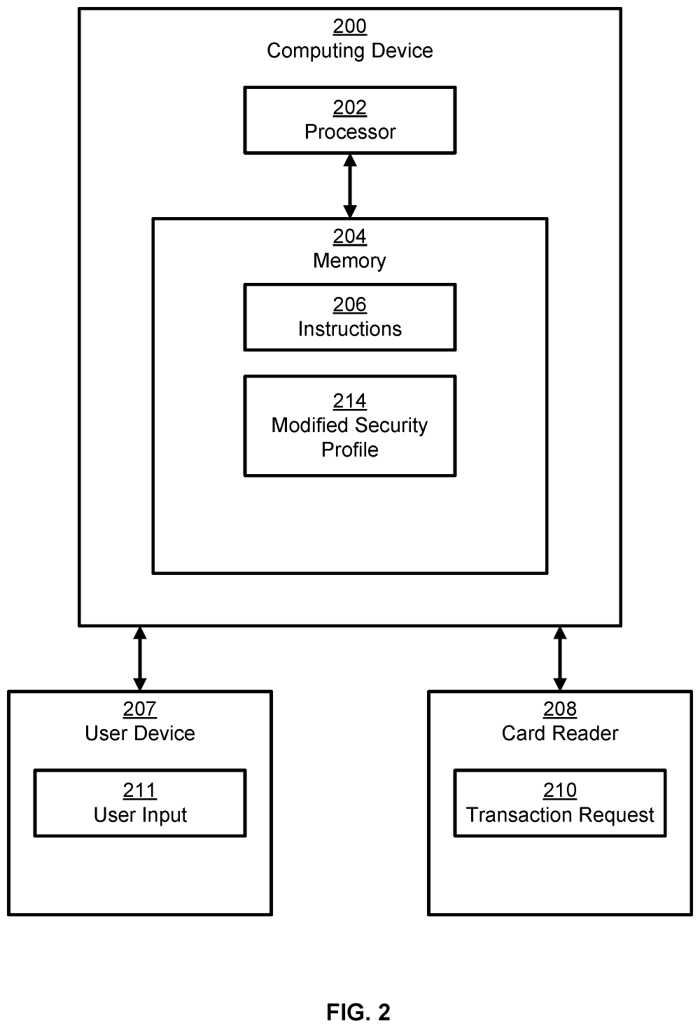

FIG. 2 is a block diagram of an example computing device according to one example of the present disclosure. The computing device 200 includes a processor 202 that is communicatively coupled to a memory 204. In some examples, the processor 202 and the memory 204 may be distributed from (e.g., remote to) one another.

The processor 202 can include one processing device or multiple processing devices. Non-limiting examples of the processor 202 include a Field-Programmable Gate Array (FPGA), an application-specific integrated circuit (ASIC), a microprocessor, etc. The processor 202 can execute instructions 206 stored in the memory 204 to perform operations. In some examples, the instructions 206 can include processor-specific instructions generated by a compiler or an interpreter from code written in a suitable computer-programming language, such as C, C++, C #, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory 204 can include a non-transitory, computer-readable medium form which the processor 202 can read instructions 206. A computer-readable medium can include electronic, optical, magnetic, or other storage devices capable of providing the processor 202 with computer-readable instructions or other program code. Non-limiting examples of a computer-readable medium include magnetic disk(s), memory chip(s), ROM, random-access memory (RAM), an ASIC, a configured processor, optical storage, or any other medium from which a computer processor can read the instructions 206. The memory 204 may further include a modified security profile 214.

The computing device 200 may be in communication with a user device 207. The user device 207 may transmit at least one user input 211, which may be associated with the modified security profile 214. The user input 211 may start, stop, or alter the parameters of the modified security profile 214.

The computing device 200 may also be in communication with a card reader 208. The card reader 208 may transmit a transaction request 210 to the computing device. The computing device 200 may respond to the transaction request 210 based on the active or inactive status of the modified security profile 214 or the parameters of the modified security profile 214.

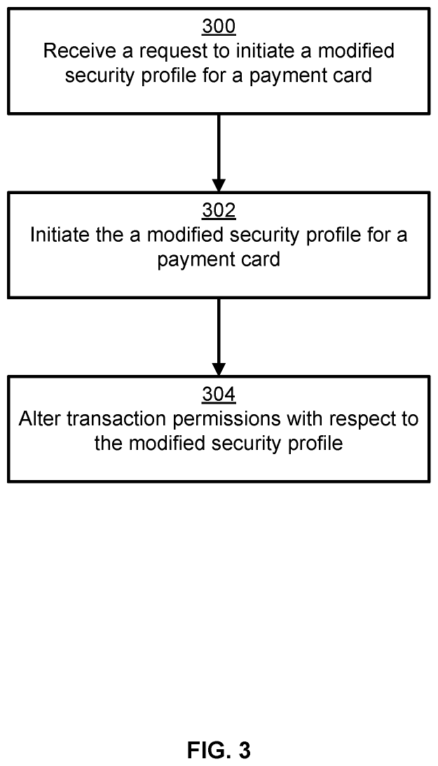

FIG. 3 is a flow chart of an example of a process for implementing some aspects of the present disclosure. In block 300, a computing device 200 receives a request to initiate a modified security profile 214 for a payment card. The request may be received through a smartphone application, a virtual assistant application, a banking website, an automated teller machine (ATM) an automated attendant responding to voice commands from a user, a virtual assistant software such as Sin®, Cortana®, Google Assistant®, Hound®, Alexa®, Robin®, Extreme®, Jarvis®, Databot®, or any other suitable virtual assistant software. The request may be issued from a phone call, a text message, or an authorized employee of a financial institution. In some examples, the request to initiate a modified security profile 214 may result from a passive lapse in activity rather than an actively issued request. For example, a request to initiate a modified security profile 214 may result from a predetermined period of time passing since a radio frequency identification device (RFID) of the payment card was last electronically paired with a smartphone of a user. The lapse in electronic pairing of the payment card and the smartphone of the user may indicate that the payment card was misplaced or that the user is no longer in possession of the payment card. Other example lapses in activity to initiate the modified security profile 214 are also possible.

In some examples, the request to initiate the modified security profile 214 may be made using a secret code by the user, such as a hand gesture on a camera of a smartphone or other gesture interaction with the smartphone. In an example, multiple gestures may be used to implement multiple modified security profiles 214, where each gesture represents a different modified security profile 214.

In an example, the modified security profile may prevent the card from being used for a specified period of time or until the user removes the modified security profile. Further, the modified security profile may restrict how the card is used. For example, while the modified security profile is in effect, a user may only be able to perform transactions such as paying a ride share application or buying groceries. In some examples when the modified security profile is implemented based on the passive lapse in activity, the location of the smartphone at the most recent electronic pairing of the payment card and the smartphone may be saved. By accessing this information, a user may be able to track where the payment card was misplaced such that the user is able to recover the payment card.

In block 302, the computing device 200 initiates the modified security profile 214 for the payment card. The modified security profile 214 may block transactions during a specified time interval. The modified security profile 214 may block transactions based on a geographical position of a device attempting to execute a transaction with an account associated with the payment card. The modified security profile 214 may alter a pre-defined spending limit for an account associated with the payment card. In some examples, the modified security profile 214 may block transactions after the pre-defined spending limit has been met, exceeded, or would otherwise be exceeded if a transaction were to be allowed. The modified security profile 214 may implement dual-factor authentication for transactions with an account associated with the payment card. For example, the modified security profile 214 may require a user of the payment card to submit to a facial recognition scan of their smartphone to complete a transaction with the payment card. The modified security profile 214 may block transactions with pre-defined entities. For example, the modified security profile may block transactions with the Apple® App Store® to prevent the child of a user from purchasing loot crates from games. In some examples, the modified security profile may prevent cash withdrawals or other ATM transactions.

In some examples, the aforementioned parameters may be combined to further define the modified security profile 214. For example, the modified security profile may block transactions from particular merchants at a first specified time span, require dual factor authentication from particular merchants at the first specified time span, and block all transactions at a second specified time span.

In block 304, the computing device 200 may alter transaction permissions with respect to the modified security profile 214. Transaction permissions may extend beyond transactions attempted with the payment card. For example, a point of sale device may transmit the card number, expiration date, and card security code in an attempt to execute a transaction. The point of sale device may not have physically scanned the card. Regardless, the computing device 200 may block the attempted transaction. In another example, the modified security profile 214 may block transactions for an account related to the payment card. For example, a merchant may attempt to use an account number and a routing number from a check to complete a transaction. The modified security profile may be related to a debit card that is associated with the same checking account as the account number and routing number. In some such example, the computing device 200 may block the attempted transaction which uses the account number and routing number.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A non-transitory computer-readable medium comprising instructions that are executable by a processing device for causing the processing device to:
receive a request to initiate a modified security profile for a payment card;
initiate the modified security profile for the payment card;
receive a request from a point of sale device to authorize a transaction by the payment card with the modified security profile;
determine that the transaction by the payment card is not authorized by the modified security profile; and
transmit a notification to the point of sale device rejecting the transaction.

2. The non-transitory computer-readable medium of claim 1, wherein the modified security profile for the payment card is configured to block transactions during a specified time interval.

3. The non-transitory computer-readable medium of claim 1, wherein the modified security profile for the payment card is configured to block transactions based on a geographical position of a device attempting to execute a transaction with an account associated with the payment card.

4. The non-transitory computer-readable medium of claim 1, wherein the modified security profile for the payment card is configured to track a pre-defined spending limit for an account associated with the payment card while the modified security profile is active.

5. The non-transitory computer-readable medium of claim 1, wherein the modified security profile for the payment card is configured to implement dual-factor authentication for transactions with an account associated with the payment card.

6. The non-transitory computer-readable medium of claim 1, wherein the modified security profile for the payment card is configured to block transactions by the payment card with pre-defined entities.

7. The non-transitory computer-readable medium of claim 1, wherein the modified security profile for the payment card is configured to block cash withdrawals.

8. A system comprising:
a processing device; and
a non-transitory computer-readable medium comprising instructions that are executable by the processing device for causing the processing device to:
receive a request to initiate a modified security profile for a payment card;
initiate the modified security profile for the payment card;
receive a request from a point of sale device to authorize a transaction by the payment card with the modified security profile;
determine that the transaction by the payment card is not authorized by the modified security profile; and
transmit a notification to the point of sale device rejecting the transaction.

9. The system of claim 8, wherein the modified security profile for the payment card is configured to block transactions during a specified time interval.

10. The system of claim 8, wherein the modified security profile for the payment card is configured to block transactions based on a geographical position of a device attempting to execute a transaction with an account associated with the payment card.

11. The system of claim 8, wherein the modified security profile for the payment card is configured to track a pre-defined spending limit for an account associated with the payment card while the modified security profile is active.

12. The system of claim 8, wherein the modified security profile for the payment card is configured to implement a dual-factor authentication for transactions with an account associated with the payment card.

13. The system of claim 8, wherein the modified security profile for the payment card is configured to block transactions with pre-defined entities and to block cash withdrawals.

14. The system of claim 8, wherein receiving the request to initiate a modified security profile for the payment card comprises an indication from a smartphone of a user that the smartphone is no longer electronically paired with the payment card.

15. A computer-implemented method comprising:
receiving a request to initiate a modified security profile for a payment card;
initiating the modified security profile for the payment card;
receiving a request from a point of sale device to authorize a transaction by the payment card with the modified security profile;
determining that the transaction by the payment card is not authorized by the modified security profile; and
transmitting a notification to the point of sale device rejecting the transaction.

16. The computer-implemented method of claim 15, wherein the modified security profile is configured to block transactions during a specified time interval.

17. The computer-implemented method of claim 15, wherein determining that the transaction by the payment card is not authorized is based on a geographical position of a device attempting to execute the transaction with an account associated with the payment card.

18. The computer-implemented method of claim 15, wherein the modified security profile is configured to track a pre-defined spending limit for an account associated with the payment card.

19. The computer-implemented method of claim 15, wherein the modified security profile is configured to require dual-factor authentication for transactions with an account associated with the payment card.

20. The computer-implemented method of claim 15, wherein the modified security profile is configured to block transactions with pre-defined entities.
